(19) United States
(12) Patent Application Publication
(10) Pub. No.: US 2019/0344498 A1
(43) Pub. Date: Nov. 14, 2019

(54) METHOD AND APPARATUS FOR MAKING A THREE-DIMENSIONAL LAMINATED OBJECT

(71) Applicant: Taiwan Green Point Enterprises Co., Ltd., Taichung City (TW)

(72) Inventors: Scott Klimczak, Taichung City (TW); Nicholas Diaco, Taichung City (TW)

(73) Assignee: Taiwan Green Point Enterprises Co., Ltd., Taichung City (TW)

(21) Appl. No.: 15/977,420

(22) Filed: May 11, 2018

(51) Int. Cl. B29C 64/147; B29C 64/218; B29C 64/264; B29C 61/06; B29C 65/14; B29C 65/48

(52) U.S. Cl. CPC B29C 64/147; B29C 64/218; B29C 64/264; B33Y 10/00; B29C 65/1406; B29C 65/4845; B29C 61/0616

(57) ABSTRACT

A method for making a three-dimensional laminated object, including: providing multiple sheet substrates each having an adhesive layer; consecutively stacking one of the sheet substrates onto a previous one of the sheet substrates on a work station, the previous one of the sheet substrates having been cut along and cured within a first contour; cutting the one of the sheet substrates along a second contour; and curing the adhesive layer of the one of the sheet substrates within the second contour to bind the one of and the previous one of the sheet substrates, where operations of the cutting and curing of the one of the sheet substrates at least partially overlap in time. An apparatus for making a three-dimensional laminated object is also provided.

### FIELD OF INVENTION

The disclosure relates to a method and an apparatus for making a three-dimensional laminated object, and more particularly to a method and an apparatus for making a three-dimensional laminated object involving operations of cutting and curing of sheet substrates at least partially overlapping in time.

### BACKGROUND

Three-dimensional printing (3D printing) has attracted much attention recently, due to its capability of rapid manufacturing 3D objects with desired shapes, which are fairly popular in the fields of industrial design, art, or even medicine.

However, conventional 3D printing techniques suffer either slow printing speed or tedious post-processing.

One kind of the conventional 3D printing technique is laminated object manufacturing (LOM), which works by heat laminating a sheet having an adhesive layer on the back surface thereof to a bed, followed by laser cutting a desired pattern on the sheet. The foregoing LOM steps are repeated to stack a plurality of cut sheets on the bed to form a 3D object with desired shape. LOM enjoys fast laminating and cutting. Nonetheless, since the entire adhesive layer of each of the sheets is heated and laminated, the undesired cutoff parts separated from the 3D object needs to be removed, which may lead to tedious post-processing.

Another kind of the conventional 3D printing technique is selective deposition lamination (SDL), which works by first attaching a paper sheet to a bed, followed by dispensing adhesive on the paper sheet, where the area inside the desired contour is dispensed with more adhesive and the area outside the desired contour is dispensed with less adhesive, and the desired contour of the top paper sheet is cut. The foregoing SDL steps are repeated to stack a plurality of cut paper sheets on the bed to form a 3D object with desired shape. The conventional SDL process ensures the undesired parts of the paper sheets are weakly bonded, thereby allowing easy removal of undesired parts from the stronger 3D object. Although the conventional SDL process enjoys faster post-processing, the adhesive dispensing process takes longer time than the conventional LOM process.

Therefore, it is desired to provide a 3D printing technique and apparatus that allow faster output.

### SUMMARY

Therefore, an object of the present disclosure is to provide a method and an apparatus for making three-dimensional laminated object that can alleviate at least one of the drawbacks associated with the prior art.

According to one aspect of this disclosure, a method for making a three-dimensional laminated object includes:

providing a plurality of sheet substrates for forming constitutive layers of the three-dimensional laminated object, each of the sheet substrates having an adhesive layer;

consecutively stacking one of the sheet substrates onto a previous one of the sheet substrates disposed on a work station, the previous one of the sheet substrates having been cut along and cured within a first contour;

cutting the one of the sheet substrates along a second contour;

curing the adhesive layer of the one of the sheet substrate within the second contour to bond the one of the sheet substrates to the previous one of the sheet substrates, where operations of the cutting and curing of the one of the sheet substrates at least partially overlap in time.

According to another aspect of this disclosure, an apparatus for making a three-dimensional laminated object includes a mainframe, a work station, a feeder, a cutter and a curer.

The work station is mounted to the mainframe. The feeder is mounted to the main frame, and is adapted to feed a plurality of sheet substrates onto the work station. The cutter is mounted to the mainframe, is disposed above the work station, and is adapted to cut one of the sheet substrates that is stacked on a previous one of the sheet substrates that has been cut along and cured within a first contour and that is disposed on the work station. The curer is mounted to the mainframe, is disposed adjacent to the cutter and above the work station, and is adapted to cure an adhesive layer of the one of the sheet substrates.

The feeder continuously feeds the sheet substrates onto the work station. The cutter cuts the one of the sheet substrates along a second contour. The curer cures the adhesive layer of the one of the sheet substrates within the second contour to bond the one of the sheet substrates to the previous one of the sheet substrates so as to form the three-dimensional laminated object.

### BRIEF DESCRIPTION OF THE DRAWINGS

Other features and advantages of the present disclosure will become apparent in the following detailed description of the embodiment with reference to the accompanying drawings, of which:

FIG. 1 is a perspective view of an embodiment of an apparatus for making a three-dimensional laminated object according to the present disclosure;

FIG. 2 is a variation of the embodiment of the apparatus;

FIG. 3 is a flow chart of an embodiment of a method for making a three-dimensional laminated object according to the present disclosure;

FIG. 4 is a perspective schematic view of the embodiment of the method, showing the processing of two sheet substrates;

FIG. 5 is a perspective schematic view showing the sheet substrates being provided as separate sheets and the embodiment of the method further including a crosshatching step, results in simplified and faster post processing;

FIG. 6 is a perspective schematic view of the embodiment of the method, showing an additional pre-cutting process that results in simplified and faster post processing; and

FIG. 7 is another variation of the embodiment of the apparatus, with two cutters and one curer.

### DETAILED DESCRIPTION

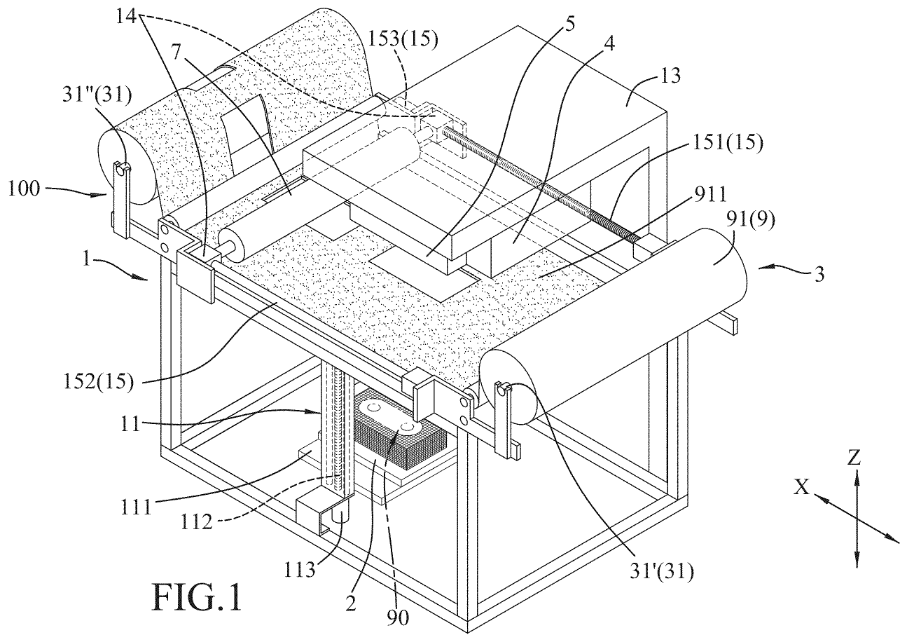

FIG. 1 shows an embodiment of an apparatus 100 for making a three-dimensional laminated object 90 according to the present disclosure.

The apparatus 100 includes a mainframe 1, a work station 2, a feeder 3, a cutter 4, a curer 5, and a pressure and heat roller 7.

The mainframe 1 includes a first moving platform 11 that is movable in a Z direction. In this embodiment, the mainframe 1 further includes a fixed first carrier 13, and a second carrier 14 that is moveable in a X direction.

The first moving platform 11 includes a moving table 111 that is movably coupled to a shaft 112, and that is drivable by a motor 113 to move along the shaft 112 (i.e., along the Z direction). Since the moving mechanism of the first moving platform 11 is well known in the art, details of the moving mechanism is not further elaborated hereinafter for the sake of brevity.

The second carrier 14 is mounted to a rail unit 15. Specifically, the rail unit 15 includes a screw 151 that extends in the X direction, a linear bearing 152 spaced apart from and parallel to the screw 151, and a motor 153 connected to the screw 151 and operable to rotate the screw 151 so as to move the second carrier 14 along the X direction.

The work station 2 is mounted to the mainframe 1. In this embodiment, the work station 2 is co-movably mounted to the moving table 111 of the first moving platform 11 to be movable along the Z direction.

The feeder 3 is mounted to the mainframe 1 and is adapted to feed onto the work station 2 a plurality of sheet substrates 9, which are to be processed and formed into the three-dimensional laminated object 90. Details of the three-dimensional laminating process according to this disclosure will be described hereinafter.

In this embodiment, the sheet substrates 9 are provided in a continuous manner (i.e., in roll-to-roll), and therefore the feeder 3 includes two rollers 31 that are rotatably mounted to the mainframe 1. The sheet substrates 9 are connected between and transferred by the rollers 31. Specifically, the sheet substrates 9 are connected in a form of continuous roll 91. One of the rollers 31 is a feeding roller 31′ and the other one of the rollers 31 is a collecting roller 31″. The continuous roll 91 is mounted to the feeding roller 31′, and the feeding roller 31′ feeds substrate 911 of the continuous roll 91 to the work station 2 to be processed. The collecting roller 31″ collects the processed substrate 911 of the continuous roll 91.

The pressure and heat roller 7 is co-movably mounted to the second carrier 14 of the mainframe 1, and may be heated by a heater (not shown).

The cutter 4 and the curer 5 are mounted to the first carrier 13 of the mainframe 1, and are disposed adjacent to each other and above the work station 2.

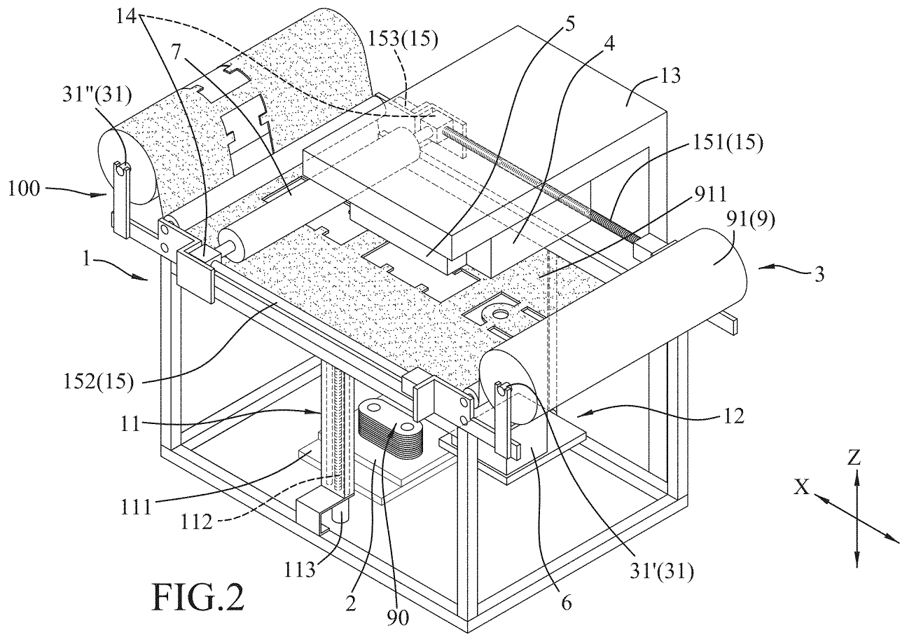

Referring to FIG. 2, a variation of the embodiment of the apparatus 100 further includes a waste container 6. The mainframe 1 further includes a second moving platform 12 that is movable in the Z direction. The waste container 6 is movably mounted to the mainframe 1 and is disposed adjacent to the work station 2. In this embodiment, the waste container 6 is mounted to the second moving platform 12 to be movable along the Z direction. The moving mechanism of the second moving platform 12 is similar to that of the first moving platform 11, and detail descriptions of the second moving platform 12 is therefore omitted.

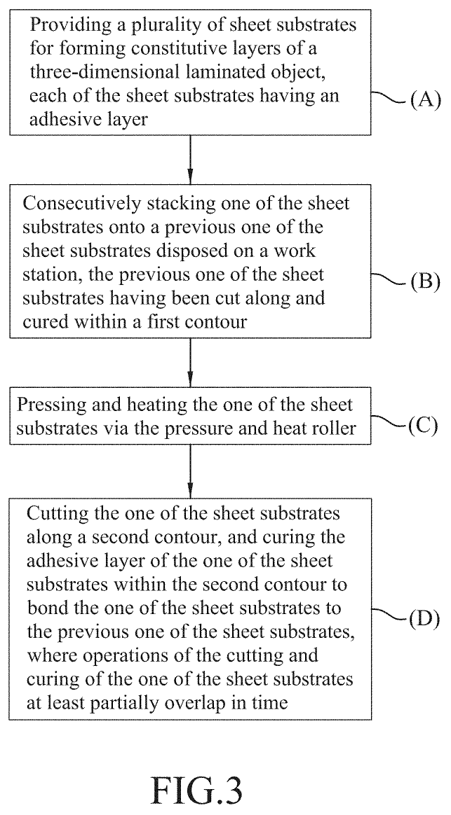

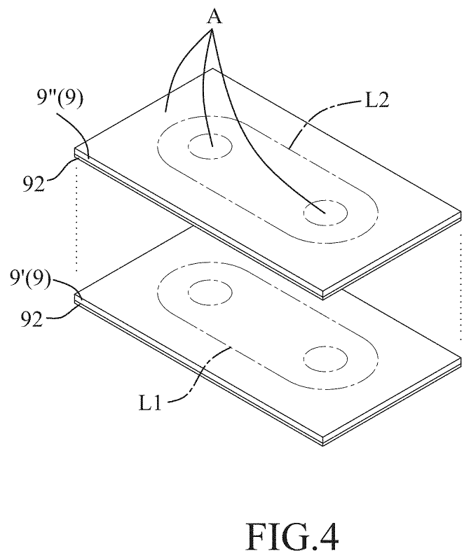

Referring further to FIGS. 3 and 4, an embodiment of a method for making the three-dimensional laminated object 90 utilizing the variation of the embodiment of the apparatus 100 will now be described.

The embodiment of the method includes:

the step (A), providing a plurality of the sheet substrates 9 for forming constitutive layers of the three-dimensional laminated object 90, each of the sheet substrates 9 having an adhesive layer 92;

the step (B), consecutively stacking one of the sheet substrates 9 onto a previous one of the sheet substrates 9 disposed on the work station 2, the previous one of the sheet substrates 9 having been cut along and cured within a first contour (L1);

the step (C), pressing and heating the one of the sheet substrates 9 via the pressure and heat roller 7; and

the step (D), cutting the one of the sheet substrates 9 along a second contour (L2), and curing the adhesive layer 92 of the one of the sheet substrates 9 within the second contour (L2) to bond the one of the sheet substrates 9 to the previous one of the sheet substrates 9, where operations of the cutting and curing of the one of the sheet substrates 9 at least partially overlap in time.

In certain embodiments, the sheet substrates 9 may be provided in roll-to-roll as described above. Therefore, in the beginning, the work station 2 is moved upwardly to be in contact with the substrate 911, followed by heating and pressing the substrate 911 via the pressure and heat roller 7 to bond a portion 9′ (i.e., the previous one of the sheet substrates 9) of the substrate 911 of the continuous roll 91 on the work station 2. The portion 9′ is then cut along and cured within the first contour (L1). Then the work station 2 is moved downwardly. Afterwards, the substrate 911 of the continuous roll 91 is advanced toward the collecting roller 31″. The work station 2 is moved upwardly again to be in contact with the substrate 911, followed by heating and pressing the substrate 911 via the pressure and heat roller 7 to bond another portion 9″ (i.e., the one of the sheet substrates 9) of the substrate 911 of the continuous roll 91 on the portion 9′. The another portion 9″ is then cut along and cured within the second contour (L2). Then the work station 2 is moved downwardly. The above described processes are repeated for multiple times to form the three-dimensional laminated object 90 constituted of the sheet substrates 9. Note that the heating and pressing process via the pressure and heat roller 7 ensures the substrate 911 is flat and initially bonded to the work station 2 or the previous one of the sheet substrates 9, thereby ensuring superior bonding quality of the subsequent curing process.

It should be noted that, based on the shape of the desired three-dimensional laminated object 90, the first contour (L1) and the second contour (L2) may be identical or different. For example, in making a cylinder, the first contour (L1) and the second contour (L2) should be circles of the same dimension in order for the stacked sheet substrates 9 to be formed into the cylinder. On the other hand, in making a pyramid, the first contour (L1) should be larger than the second contour (L2) since the pyramid is tapered from bottom to top.

With the cutting and curing of the second sheet substrate 9″ to be partially overlapped in time, the process period is shortened and the output of the apparatus 100 is increased. In certain embodiment, the cutting and curing of the one of the sheet substrates 9 (i.e., the second sheet substrate 9″) are conducted simultaneously, thereby achieving an even faster output speed.

Referring to FIG. 4, in any one of the sheet substrates 9, a region (A) of the sheet substrate 9 that is to be scrapped may be partially cured or without curing. A partial cure provides structural stability to the manufacturing process.

The continuous roll 91 may be made with an adhesive film attached thereon. As a result, each of the sheet substrates 9 is pre-formed with the adhesive layer 92. Alternatively, before curing, each of the sheet substrates 9 may be coated with a layer of adhesive by using an adhesive dispenser (not shown) to form the adhesive layer 92. The adhesive layer 92 may be provided on a top surface, bottom surface or both surfaces of each of the sheet substrates 9, and may be made of a photopolymerizable material (e.g., a UV-curable material), an electromagnetic responsive material, a synergistic stimulable material, a thermal setting material, a thixotropic material, etc. The type of the curer 5 should be changed to provide suitable curing capability to accommodate different types of the adhesive layer 92. In certain embodiments, the curer 5 is a digital light processing scanner. In certain embodiments, each of the sheet substrates 9 is made of a UV-penetrable material, the adhesive layer 92 is made of a UV-curable material, and the curer 5 is a UV light curer (i.e., the curing of the one of the sheet substrates 9 is conducted by using the UV light curer).

The cutter 4 may be a laser cutter (e.g., a UV laser, a Nd:YAG laser, a carbon dioxide laser, etc.), a water jet, a scanning electron beam cutter, etc., and is selected according to practical requirements. In certain embodiments, the cutter 4 is a laser cutter focused by a three-axis galvanometer scanner.

In certain embodiments, the cutter 4 is a laser cutter actuated by a two-axis galvanometer or a three-axis galvanometer, and the curer 5 is a digital light processing scanner.

It should be noted that the cutter 4 and the curer 5 should not be limited to the embodiments described above, as long as the cutting and curing of the sheet substrates 9 can be conducted at least partially overlapping in time and the sheet substrates 9 can be cut and cured.

Since the adhesive layer 92 may shrink while it is being cured, it may be beneficial to conduct a two-step curing process that includes pre-curing and post-curing. That is, before the cutting and post-curing of the one of the sheet substrates 9, a portion of the adhesive layer 92 of the one of the sheet substrates 9 is pre-cured within the second contour (L2). Alternatively, during the curing and the cutting of the one of the sheet substrates 9, the adhesive layer 92 of the one of the sheet substrates 9 is partially cured, and the method further includes fully curing the adhesive layer 92 of the one of the sheet substrates 9 after the cutting and curing of the one of the sheet substrates 9.

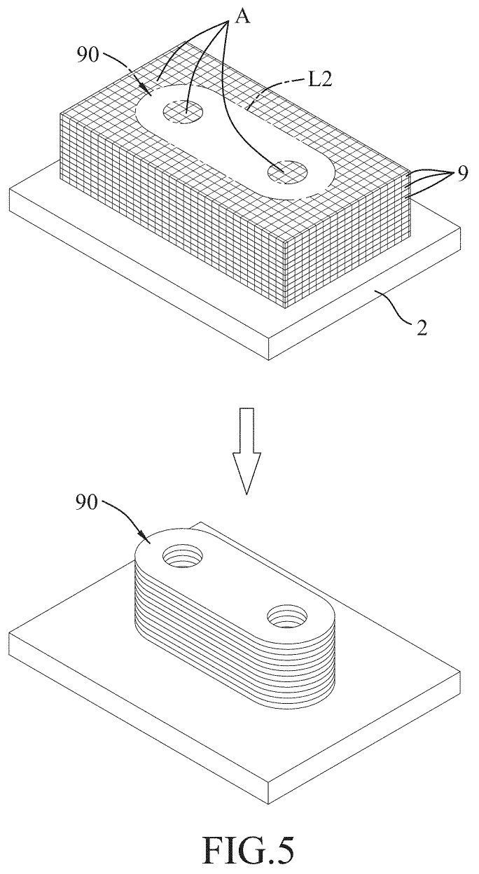

Referring further to FIG. 5, in certain embodiments, the method may further include crosshatching the one of the sheet substrates 9 in the region (A). The crosshatched portion of the sheet substrates 9 are formed into multiple waste columns when pressed by the pressure and heat roller 7, and can be easily removed, thereby facilitating waste removal after the three-dimensional laminated object 90 is formed.

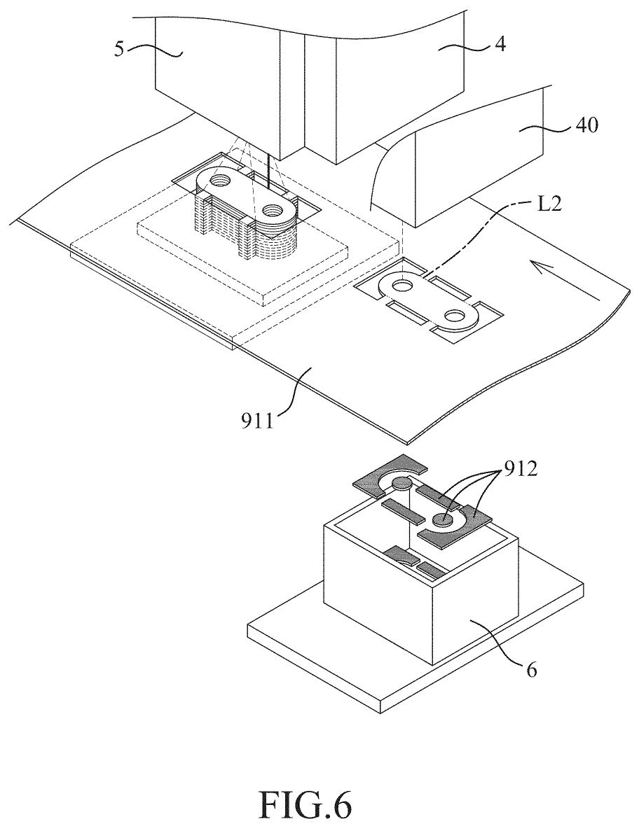

Referring further to FIG. 6, in certain embodiments, the method further includes, prior to the stacking of the one of the sheet substrates 9, cutting the one of the sheet substrates 9 to remove a portion of the one of the sheet substrates 9 that is outside of the second contour (L2). Specifically, the apparatus 100 may further include an additional cutter 40 that is mounted to the mainframe 1. The portion of the substrate 911 of the continuous roll 91 is cut by the additional cutter 40, and the waste container 6 located below collects waste materials 912 cut from the substrate 911 of the continuous roll 91, followed by advancing the cut portion of the substrate 911 of the continuous roll 91 to be located above the work station 2 for cutting by the cutter 4 and curing by the curer 5. Such pre-cutting process results in a simplified and faster post processing. It is worth mentioning that the cutter 4 is operable to reach the cutting area of the additional cutter 40, and the additional cutter 40 is operable to reach the cutting area of the cutter 4, thereby providing a more flexible cutting mechanism. Both the cutter 4 and the additional cutter 40 are operable to simultaneously cutting the same area to reduce the cutting time and balance the cycle time. In certain embodiments, if the curing time is greater than the cutting time, the pre-cutting process may be conducted using the cutter 4, the additional cutter 40, or both the cutter 4 and the additional cutter 40.

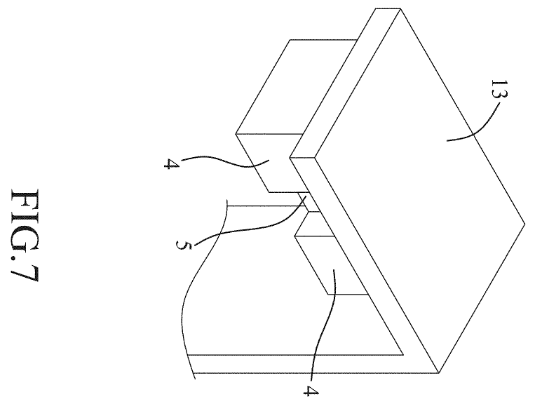

Referring to FIG. 7, another variation of the embodiment of the apparatus includes two of the cutters 4, with the curer 5 connected between the cutters 4. In certain embodiments, the cutters 4 may be CO2 lasers, and the curer 5 may be a digital light processing scanner. The provision of additional cutter 4 would increase throughput of the apparatus. Specifically, the cutters 4 may be used for cutting the same area simultaneously or alternatingly to balance the cycle time. Alternatively, the additional cutter 4 may function as the additional cutter 40 for pre-cutting.

In summary, the at least partially overlap in time of the cutting and curing processes allows the method of this disclosure to have greater output. With the combination of the curing (one-step or two-step curing), cutting and crosshatching, the method of this disclosure can be adapted to make different kinds of three-dimensional laminated objects according to practical requirements. The pre-cutting process working with the waste container 6 provides a simplified and faster post processing.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for making a three-dimensional laminated object, comprising:
providing a plurality of sheet substrates for forming constitutive layers of the three-dimensional laminated object, each of the sheet substrates having an adhesive layer;
consecutively stacking one of the sheet substrates onto a previous one of the sheet substrates disposed on a work station, the previous one of the sheet substrates having been cut along and cured within a first contour;
cutting the one of the sheet substrates along a second contour; and
curing the adhesive layer of the one of the sheet substrate within the second contour to bond the one of the sheet substrates to the previous one of the sheet substrates, where operations of the cutting and curing of the one of the sheet substrates at least partially overlap in time.

2. The method as claimed in claim 1, wherein the cutting and curing of the one of the sheet substrates are conducted simultaneously.

3. The method as claimed in claim 1, further comprising crosshatching the one of the sheet substrates after the stacking of the one of the sheet substrates.

4. The method as claimed in claim 1, wherein:
during the curing and the cutting of the one of the sheet substrates, the adhesive layer of the one of the sheet substrates is partially cured; and
the method further comprises after the cutting and curing of the one of the sheet substrates, fully curing the adhesive layer of the one of the sheet substrates.

5. The method as claimed in claim 1, wherein the sheet substrates are connected to each other in a continuous manner.

6. The method as claimed in claim 1, further comprising prior to the stacking of the one of the sheet substrates, cutting the one of the sheet substrates to remove a portion of the one of the sheet substrates that is outside of the second contour.

7. The method as claimed in claim 1, further comprising before the cutting and curing of the one of the sheet substrates, curing a portion of the adhesive layer of the one of the sheet substrates within the second contour.

8. The method as claimed in claim 1, wherein each of the sheet substrates is made of a UV-penetrable material, the adhesive layer being made of a UV-curable material, the curing of the one of the sheet substrates being conducted by using a UV light curer.

9. An apparatus for making a three-dimensional laminated object, said apparatus comprising:
a mainframe;
a work station mounted to said mainframe;
a feeder mounted to said mainframe and adapted to feed a plurality of sheet substrates onto said work station;
a cutter mounted to said mainframe, disposed above said work station, and adapted to cut one of the sheet substrates that is stacked on a previous one of the sheet substrates that has been cut along and cured within a first contour and that is disposed on said work station; and
a curer mounted to said mainframe, disposed adjacent to said cutter and above said work station, and adapted to cure an adhesive layer of the one of the sheet substrates,
wherein said feeder continuously feeds the sheet substrates onto said work station, said cutter cutting the one of the sheet substrates along a second contour, said curer curing the adhesive layer of the one of the sheet substrates within the second contour to bond the one of the sheet substrates to the previous one of the sheet substrates so as to form the three-dimensional laminated object.

10. The apparatus as claimed in claim 9, further comprising a waste container movably mounted to said mainframe and disposed adjacent to said work station.

11. The apparatus as claimed in claim 9, further comprising a pressure and heat roller movably mounted to said mainframe and adapted to press the one of the sheet substrates stacked on the previous one of the sheet substrates disposed on said work station so as to connect the one of the sheet substrates with the previous one of the sheet substrates.

12. The apparatus as claimed in claim 9, wherein the sheet substrates are provided in a continuous manner, said feeder including two rollers rotatably mounted to said mainframe, the sheet substrates being connected between and transferred by said rollers.
